(19) United States
(12) Patent Application Publication
(10) Pub. No.: US 2021/0300815 A1
(43) Pub. Date: Sep. 30, 2021

(54) PARTICLE MIXTURE, KIT, INK, METHODS AND ARTICLE

(71) Applicant: JOHNSON MATTHEY PUBLIC LIMITED COMPANY, London (GB)

(72) Inventors: Geert BENTEM, Maastricht (NL); Edwin Peter Kennedy CURRIE, Maastricht (NL); Jean Luc LOONTJENS, Maastricht (NL); Nikolina PAVLOVIC, Maastricht (NL); Syarif RIYADI, Maastricht (NL)

(21) Appl. No.: 17/260,366

(22) PCT Filed: Jul. 12, 2019
(86) PCT No.: PCT/GB2019/051955

§ 371 Date: Jan. 14, 2021

(30) Foreign Application Priority Data
Jul. 24, 2018 (GB) 1812052.7

(51) Int. Cl. C03C 8/16; C03C 8/02; C03C 8/04; C03C 3/062; C03C 8/22; C03C 17/04

(52) U.S. Cl. CPC C03C 8/16; C03C 8/02; C03C 8/04; C03C 2207/00; C03C 8/22; C03C 17/04; C03C 3/062

(57) ABSTRACT

A particle mixture for forming an enamel comprising particles of a first glass frit and particles of a second glass frit; wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns. Also described is an ink comprising the particle mixture, methods of preparing the ink, an article formed using the ink, and a kit comprising particles of the first and second glass frit.

### FIELD OF THE INVENTION

The present invention relates to a kit, a particle mixture and an ink suitable for applying an enamel to a substrate, a method for preparing an ink and a method of forming an enamel on a substrate. The present invention further relates to an article comprising a substrate having an enamel formed thereon.

### BACKGROUND OF THE INVENTION

Enamels are widely used to decorate or produce coatings on glass and ceramic substrates, such as tableware, signage, tiles, architectural glass etc. Enamels are especially useful in forming coloured borders around glass sheets used for automotive windshields, side windows (sidelites) and rear windows (backlites). The coloured borders enhance appearance as well as preventing degradation of underlying adhesives by UV radiation. Moreover, the coloured borders may conceal buss bars and wiring connections of glass defrosting systems.

Enamels typically comprise pigment and glass frit. In general, they are applied to a substrate (e.g. a windshield surface) as an ink, e.g. by printing. The ink may comprise particles of pigment and glass frit dispersed in a liquid dispersion medium. Such inks may be referred to as “inorganic ceramic inks”. After application of a coating of ink to the substrate, the ink is typically dried and the applied coating undergoes firing, i.e. is subjected to heat treatment to cause the frit to soften and fuse to the substrate; thereby adhering an enamel to the substrate. During firing, the pigment itself typically does not melt, but is affixed to the substrate by or with the frit.

Various printing techniques may be employed for the application of inorganic ceramic inks to a substrate. For example, screen printing and pad printing are commonly employed. Digital inkjet printing has also been employed for the application of such inks to a substrate. Digital printing can provide various advantages over screen printing, for example: reduction of costs involved in storage of screens or transfer devices (due to digital storing of the desired patterns); reduction of costs for low value printing, which may be prohibitive in screen-printing; increased ease and versatility of switching from one design to another; and capacity for edge to edge printing. However, inks suitable for screen or pad printing are typically unsuitable for application via inkjet printing, as they tend to have a viscosity which is too high, and the particle size of the glass frit and pigment particles may be such that the particles could clog the nozzles of an inkjet printer. Typically, an inorganic ceramic ink suitable for inkjet printing (i.e. inkjettable) will have a viscosity of less than 20 cps (at printing temperature) and the particles dispersed therein will have a particle size of less than 2 microns, preferably less than 1 micron.

Proper frit selection is crucial in the preparation of inorganic ceramic inks since the fit properties influence both the firing behavior and the properties of the final, fired enamel. In general, inorganic ceramic inks comprise particles of glass frit having a single glass composition. Typically, the composition of the glass frit comprises silica, bismuth oxide and boron oxide.

EP 1658342, for example, describes an ink-jet ink composition for printing on a ceramic substrate, which ink composition comprises an organic solvent as a vehicle which is liquid at room temperature and, as a binding composition, sub-micron particles of a glass frit composed of SiO₂, Bi₂O₃ and B₂O₃, having a particle size of less than 0.9 microns.

Surprisingly, the present inventors have found that the use of a particle mixture comprising particles of a first glass frit which comprises silica but little or no boron oxide and particles of a second glass frit which comprises boron but little or no silica, may provide several advantages. In particular, the temperature range at which the enamel fuses to the substrate during firing can be better controlled. Further, functional properties of the final enamel such as depth of color and bending strength may be improved.

### SUMMARY OF THE INVENTION

According to the present invention, there is provided a kit comprising particles of a first glass frit and particles of a second glass frit; wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns.

According to a second aspect of the present invention, there is provided a particle mixture for forming an enamel comprising particles of a first glass frit and particles of a second glass frit; wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns.

According to a second aspect of the present invention, there is provided an ink for forming an enamel comprising:
particles of a first glass frit;
particles of a second glass frit; and
a liquid dispersion medium;
   wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns.

According to a further aspect of the present invention there is provided a method of preparing an ink comprising mixing in any order:
a) particles of a first glass frit;
b) particles of a second glass frit; and
c) a liquid dispersion medium;
   wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns.

According to a further aspect of the present invention there is provided a method of preparing an ink which comprises:
(i) milling a mixture comprising particles of a first glass frit and liquid dispersion medium, wherein the first glass frit comprises greater than 5 wt % silicon oxide (SiO₂) and less than 5 wt % boron oxide (B₂O₃), to provide a first dispersion in which the particles of the first glass frit have a D90 particle size of less than 5 microns;
(ii) milling a mixture comprising particles of a second glass frit and liquid dispersion medium, wherein the second glass frit comprises boron oxide (B₂O₃) and less than 5 wt % silicon oxide (SiO₂), to provide a second dispersion in which the particles of the second glass frit have a D90 particle size of less than 5 microns;
(iii) mixing the first dispersion and the second dispersion; wherein steps (i) and (ii) may be carried out in any order.

According to a further aspect of the present invention there is provided a method of preparing an ink comprising:
(i) combining:
   a) particles of a first glass frit comprising greater than 5 wt % silicon oxide (SiO₂) and less than 5 wt % boron oxide (B₂O₃);
   b) particles of a second glass frit comprising boron oxide (B₂O₃) and less than 5 wt % silicon oxide (SiO₂); and
   c) a liquid dispersion medium;
(ii) milling the combination resulting from step (i) to provide an ink in which both the particles of the first glass frit and the particles of the second glass frit have a D90 particle size of less than 5 microns.

According to yet a further aspect of the present invention, there is provided a method of forming an enamel on a substrate, the method comprising applying a coating of an ink as described above onto the substrate and firing the applied coating.

According to yet another aspect, there is provided an article comprising a substrate having an enamel formed thereon, wherein the enamel is obtained or obtainable by the method described above.

According to yet another aspect, there is provided the use of a particle mixture or an ink as described above to form an enamel on a substrate.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

Where ranges are specified herein it is intended that each endpoint of the range is independent. Accordingly, it is expressly contemplated that each recited upper endpoint of a range is independently combinable with each recited lower endpoint, and vice versa.

The kit and the particle mixture of the present invention each comprise particles of a first glass frit, which first glass frit comprises greater than 5 wt % silicon oxide (SiO₂) and less than 5 wt % boron oxide (B₂O₃) and particles of a second glass frit, which second glass frit comprises boron oxide (B₂O₃) and less than 5 wt % silicon (SiO₂).

As will be understood by the skilled person, a glass material, such as a glass frit, is typically an amorphous material which exhibits a glass transition.

In the glass frit compositions described herein, amounts of components are given as weight percentages. These weight percentages are with respect to the total weight of the glass frit composition. The weight percentages are the percentages of the components used as starting materials in preparation of the glass frit compositions, on an oxide basis. As the skilled person will understand, starting materials other than oxides of a specific element may be used in preparing the glass frits of the present invention. Where a non-oxide starting material is used to supply an oxide of a particular element to the glass frit composition, an appropriate amount of starting material is used to supply an equivalent molar quantity of the element had the oxide of that element been supplied at the recited wt %. This approach to defining glass frit compositions is typical in the art. As the skilled person will readily understand, volatile species (such as oxygen) may be lost during the manufacturing process of the glass frit, and so the composition of the resulting glass frit may not correspond exactly to the weight percentages of starting materials, which are given herein on an oxide basis.

Analysis of a fired glass frit by a process known to those skilled in the art, such as Inductively Coupled Plasma Emission Spectroscopy (ICP-ES), can be used to calculate the starting components of the glass frit composition in question.

The first glass frit employed in the present invention may comprise 10 wt % or more, 15 wt % or more, 25 wt % or more, 28 wt % or more, 30 wt % or more, 33 wt % or more, or 35 wt % or more SiO₂. The first glass frit may include 65 wt % or less, 60 wt % or less, 50 wt % or less, 40 wt % or less, or 37 wt % or less of SiO₂. For example, the first glass frit may include ≥10 to ≤65 wt %, preferably, ≥15 to ≤50 wt % of SiO₂.

The first glass frit comprises less than 5 wt % boron. In some embodiments, the first glass frit may comprise 4 wt % or less, 3 wt % or less, 2 wt % or less, 1 wt % or less, 0.8 wt % or less, 0.5 wt % or less, or 0.2 wt % or less B₂O₃. In some embodiments, the first glass frit comprises no intentionally added B₂O₃.

As will be readily understood by the skilled person, during manufacture of glass frit, the glass composition may be contaminated with low levels of impurities. For example, in a melt/quench glass forming process, such impurities may derive from refractory linings of vessels employed in the melting step. Thus, whilst a total absence of a particular component in a glass composition may be desirable, in practice this may be difficult to achieve. As used herein, the term “no intentionally added X”, where X is a particular component, means that no raw material was employed in the manufacture of the glass frit which was intended to deliver X to the final glass composition, and the presence of any low levels of X in the glass frit composition is due to contamination during manufacture.

The first glass frit may further comprise bismuth oxide (Bi₂O₃). The first glass frit may include 10 wt % or more, 15 wt % or more, 20 wt % or more, 22 wt % or more, 25 wt % or more, 30 wt % or more, 35 wt % or more, 40 wt % or more, 45 wt % or more, or 50 wt % or more Bi₂O₃. The first glass frit may include 80 wt % or less, 75 wt % or less, 70 wt % or less, 65 wt % or less, 60 wt % or less, or 58 wt % or less Bi₂O₃. For example, the first glass frit may include ≥10 to ≤80 wt %, preferably ≥35 to ≤75 wt % of Bi₂O₃.

The first glass frit may further include zinc oxide (ZnO). The first glass frit may include 0 wt % or more, 5 wt % or more, 10 wt % or more, 12 wt % or more, 25 wt % or more, or 30 wt % or more ZnO. The first glass frit may include 50 wt % or less, 45 wt % or less, 40 wt % or less, 37 wt % or less, or 35 wt % or less of ZnO. For example, the first glass frit may include ≥0 to ≤50 wt %, preferably ≥5 to ≤40 wt %, more preferably ≥10 to ≤35 wt % of ZnO.

In some embodiments, the first glass frit is substantially free of lead, that is the first glass frit comprises less than 1 wt % PbO. For example, the first glass frit may include less than 0.5 wt % PbO, less than 0.1 wt % PbO, less than 0.05 wt %, less than 0.01 wt % or less than 0.005 wt % PbO. In one embodiment, the first glass frit may comprise no intentionally added PbO.

The first glass frit may further include alkali metal oxide, for example one or more selected from Li₂O, Na₂O, K₂O, and Rb₂O, preferably one or more selected from Li₂O, Na₂O and K₂O. For example, the first glass frit may include 0 wt % or more, 2 wt % or more, 4 wt % or more, 6 wt % or more, 6.5 wt % or more, 7 wt % or more, or 7.5 wt % or more alkali metal oxide. The first glass frit may include 18 wt % or less, 15 wt % or less, 14 wt % or less, 12 wt % or less, 10 wt % or less, or 8 wt % or less alkali metal oxide.

In particular, the first glass frit may include 0 wt % or more, 0.1 wt % or more, 0.5 wt % or more, 1 wt % or more, 2 wt % or more, or 2.5 wt % or more Li₂O. The first glass frit may include 4 wt % or less, 3 wt % or less, 2.5 wt % or less, 2 wt % or less Li₂O. For example, the first glass fit may include ≥0 to ≤4 wt % of Li₂O, preferably ≥1 to ≤3 wt % of Li₂O.

The first glass fit may include 0 wt % or more, 0.1 wt % or more, 0.5 wt % or more, 1 wt % or more, 2 wt % or more, 3 wt % or more, 4 wt % or more, or 5 wt % or more Na₂O. The first glass frit may include 12 wt % or less, 10 wt % or less, 8 wt % or less, 6 wt % or less, or 5 wt % or less Na₂O. For example, the first glass frit may include ≥0 to ≤10 wt % of Na₂O, preferably ≥2 to ≤6 wt % of Na₂O.

The first glass fit may include 0 wt % or more, 0.1 wt % or more, 0.5 wt % or more, 1 wt % or more, 1.5 wt % or more, 2 wt % or more K₂O. The first glass fit may include 3 wt % or less 2.5 wt % or less, 2 wt % or less K₂O. For example, the first glass fit may include ≥0 to ≤3 wt % of K₂O, preferably ≥1.5 to ≤3 wt % of K₂O.

The first glass fit may include further components, such as further oxide components. The further components may comprise alkali-earth metal oxides, and/or transition metal oxides. For example, the further components may include calcium oxide, iron oxide and/or titanium oxide. In some embodiments, the first glass fit may comprise certain non-oxide components, such as fluorine or sulphur cations.

In one embodiment of the present invention, the first glass frit may comprise:
a) >5 to ≤65 wt % SiO₂;
b) ≥0 to ≤50 wt % ZnO;
c) ≥10 to ≤80 wt % Bi₂O₃; and
d) ≥0 to <5 wt % B₂O₃.

The first glass frit may consist essentially of a composition as described herein, and incidental impurities (such as impurities picked up during manufacture of the glass frit). In that case, as the skilled person will readily understand that the total weight % of the recited constituents will be 100 wt %, any balance being incidental impurities. Typically, any incidental impurity will be present at 1 wt % or less, preferably 0.5 wt % or less, more preferably 0.2 wt % or less.

In one embodiment, the first glass frit may consist essentially of:
a) >5 to ≤65 wt % SiO₂;
b) ≥0 to ≤50 wt % ZnO;
c) ≥10 to ≤80 wt % Bi₂O₃;
d) ≥0 to <5 wt % B₂O₃;
e) ≥0 to ≤18 wt % alkali metal oxide;
f) ≥0 to ≤10 wt % of further components, which may optionally be selected from the group consisting of alkali earth metal oxides, transition metal oxides, fluorine and sulphur; and
g) incidental impurities.

The expression “consists essentially of” embraces the expression “consists of”.

The second glass frit employed in the present invention may comprise 3 wt % or more, 5 wt % or more, 8 wt % or more, 10 wt % or more, 15 wt % or more, or 18 wt % or more B₂O₃. The second glass frit may include 25 wt % or less, 22 wt % or less, or 20 wt % or less of B₂O₃. For example, the second glass frit may include ≥5 to ≤25 wt %, preferably, ≥8 to ≤20 wt % of B₂O₃.

The second glass frit comprises less than 5 wt % SiO₂. In some embodiments, the first glass frit may comprise 4 wt % or less, 3 wt % or less, 2 wt % or less, 1 wt % or less, 0.8 wt % or less, 0.5 wt % or less, or 0.2 wt % or less SiO₂. In some embodiments, the second glass frit may comprise no intentionally added SiO₂.

The second glass frit may further comprise bismuth oxide (Bi₂O₃). The second glass frit may include 10 wt % or more, 15 wt % or more, 20 wt % or more, 25 wt % or more, 30 wt % or more, 35 wt % or more or 40 wt % or more Bi₂O₃. The second glass frit may include 70 wt % or less, 65 wt % or less, 60 wt % or less, or 55 wt % or less Bi₂O₃. For example, the second glass frit may include ≥35 to ≤70 wt %, preferably ≥40 to ≤55 wt % of Bi₂O₃.

The second glass frit may further include zinc oxide (ZnO). The second glass fit may include 5 wt % or more, 8 wt % or more, 10 wt % or more, 15 wt % or more, or 20 wt % or more ZnO. The second glass frit may include 30 wt % or less, 28 wt % or less, 25 wt % or less, or 23 wt % or less of ZnO. For example, the second glass frit may include ≥5 to ≤28 wt %, preferably ≥8 to ≤25 wt % of ZnO.

The second glass fit may further include tin oxide (SiO₂). The second glass fit may include 0 wt % or more, 4 wt % or more, 5 wt % or more, 8 wt % or more, 10 wt % or more, 15 wt % or more, 19 wt % or more, or 20 wt % or more SiO₂. The second glass frit may include 30 wt % or less, 27 wt % or less, 25 wt % or less, 23 wt % or less, or 21 wt % or less of SiO₂. For example, the second glass frit may include ≥0 to ≤30 wt %, ≥4 to ≤25 wt %, preferably ≥6 to ≤21 wt % wt % of SnO₂.

The second glass frit may further include aluminium oxide (Al₂O₃). The second glass frit may include 0 wt % or more, 4 wt % or more, 5 wt % or more, 8 wt % or more, 10 wt % or more Al₂O₃. The second glass frit may include 20 wt % or less, 18 wt % or less, or 15 wt % or less of Al₂O₃. For example, the second glass frit may include ≥0 to ≤20 wt % Al₂O₃.

The second glass frit may further include alkali metal oxide, for example one or more selected from Li₂O, Na₂O, K₂O, and Rb₂O, preferably one or more selected from Li₂O, Na₂O and K₂O. For example, the second glass frit may include 0 wt % or more, 2 wt % or more, 4 wt % or more, 6 wt % or more, 6.5 wt % or more, 7 wt % or more, or 7.5 wt % or more alkali metal oxide. The second glass frit may include 18 wt % or less, 15 wt % or less, 14 wt % or less, 12 wt % or less, 10 wt % or less, or 8 wt % or less alkali metal oxide.

In particular, the second glass frit may include 0 wt % or more, 0.1 wt % or more, 0.5 wt % or more, 1 wt % or more, 2 wt % or more, or 2.5 wt % or more Li₂O. The second glass frit may include 4 wt % or less, 3 wt % or less, 2.5 wt % or less, 2 wt % or less Li₂O. For example, the second glass frit may include ≥0 to ≤3 wt %, preferably ≥1 to ≤3 wt % of Li₂O.

The second glass frit may include 0 wt % or more, 0.1 wt % or more, 0.5 wt % or more, 1 wt % or more, 2 wt % or more, 3 wt % or more, 4 wt % or more, or 5 wt % or more Na₂O. The second glass frit may include 12 wt % or less, 10 wt % or less, 8 wt % or less, 6 wt % or less, or 5 wt % or less Na₂O. For example, the second glass frit may include ≥0 to ≤10 wt %, preferably ≥2 to ≤6 wt % of Na₂O.

The second glass frit may include 0 wt % or more, 0.1 wt % or more, 0.5 wt % or more, 1 wt % or more, 1.5 wt % or more, 2 wt % or more K₂O. The second glass frit may include 3 wt % or less 2.5 wt % or less, 2 wt % or less K₂O. For example, the second glass frit may include ≥1.5 to ≤3 wt % of K₂O.

The second glass frit may include further components, such as further oxide components. The further components may comprise alkali-earth metal oxides, and/or transition metal oxides. For example, the further components may include calcium oxide, iron oxide and/or titanium oxide. In some embodiments, the second glass frit may comprise certain non-oxide components, such as fluorine or sulphur cations.

In some embodiments, the second glass frit is substantially free of lead, that is the second glass frit comprises less than 1 wt % PbO. For example, the second glass fit may include less than 0.5 wt % PbO, less than 0.1 wt % PbO, less than 0.05 wt %, less than 0.01 wt % or less than 0.005 wt % PbO. In one embodiment, the second glass fit may comprise no intentionally added PbO,

In one embodiment of the present invention, the second glass frit may comprise:
a) >1 to ≤25 wt % B₂O₃;
b) ≥5 to ≤30 wt % ZnO;
c) ≥40 to ≤70 wt % Bi₂O₃;
d) ≥0 to ≤30 wt % SnO₂;
e) ≥0 to ≤20 wt % Al₂O₃;
f) ≥0 to <5 SiO₂ wt %; and
g) ≥0 to ≤18 wt % alkali metal oxide.

The second glass frit may consist essentially of a composition as described herein, and incidental impurities (such as impurities picked up during manufacture of the glass frit). In that case, as the skilled person will readily understand that the total weight % of the recited constituents will be 100 wt %, any balance being incidental impurities. Typically, any incidental impurity will be present at 1 wt % or less, preferably 0.5 wt % or less, more preferably 0.2 wt % or less.

In one embodiment, the second glass frit may consist essentially of:
a) >1 to ≤25 wt % B₂O₃;
b) ≥5 to ≤30 wt % ZnO;
c) ≥40 to ≤70 wt % Bi₂O₃;
d) ≥0 to ≤30 wt % SnO₂;
e) ≥0 to <5 SiO₂ wt %; ≥0 to ≤20 wt % Al₂O₃;
f) ≥0 to ≤18 wt % alkali metal oxide;
g) ≥0 to ≤10 wt % of further components, which may optionally be selected from the group consisting of alkali earth metal oxides, transition metal oxides, fluorine and sulphur; and
h) incidental impurities.

Particles of glass frit may be prepared by mixing together the required raw materials and melting them to form a molten glass mixture, then quenching to form a glass (melt/quench glass forming). The skilled person is aware of alternative suitable methods for preparing glass frit. Suitable alternative methods include water quenching, sol-gel processes and spray pyrolysis. The process may further comprise milling the resulting glass frit to provide glass frit particles of the desired particle size. For example, the glass frit may be milled using a bead-milling process, such as wet bead-milling in an alcohol-based or a water-based solvent.

In some embodiments of the present invention, the first and/or second glass fits may include a crystalline portion in addition to an amorphous glass phase. The use of such glass frits may promote or induce crystallisation of the frits during firing, which may be advantageous in certain applications.

In the kit, particle mixture and ink of the present invention, both the particles of the first glass frit and the particles of the second glass frit have a D90 particle size of less than 5 microns. In some embodiments, the particles of the first glass frit and/or the particles of the second glass frit may have a D90 particle size of less than 4.8 microns, less than 4 microns, less than 3.5 microns, less than 3 microns, less than 2.5 microns, less than 2 microns, or less than 1.5 microns.

The term “D90 particle size” herein refers to particle size distribution, and a value for D90 particle size corresponds to the particle size value below which 90%, by volume, of the total particles in a particular sample lie. The D90 particle size may be determined using a laser diffraction method (e.g. using a Malvern Mastersizer 2000).

In one embodiment, the particles of the first glass frit and/or the particles of the second glass frit may have a D50 particle size of less than 1 micron. In some embodiments, both the particles of the first glass frit and the particles of the second glass frit have a D50 particle size of less than 0.9 microns, or less than 0.75 microns.

The term “D50 particle size” herein refers to particle size distribution, and a value for D50 particle size corresponds to the particle size value below which 50%, by volume, of the total particles in a particular sample lie. The D50 particle size may be determined using a laser diffraction method (e.g. using a Malvern Mastersizer 2000).

Additionally, (with the caveat that the D90 particle size is always higher than the D50 particle size), both the particles of the first glass frit and the particles of the second glass frit have a D90 particle size of at least 1 micron, at least 1.2 microns, or at least 1.4 microns.

In one embodiment, the D90 particle size of the particles of the first glass frit may be approximately the same as the D90 particle size of the particles of the second glass frit. In some embodiments, the D50 particle size of the particles of the first glass frit may be approximately the same as the D50 particle size of the particles of the second glass frit.

In an alternative embodiment, the D90 and/or D50 particle size of the particles of the first glass frit may be substantially different to the respective particle size of the particles of the second glass frit. For example, the particles first glass frit may have a D90 particle size which is greater than the D90 particle size of the particles of the second glass frit, and/or the particles first glass frit may have a D50 particle size which is greater than the D50 particle size of the particles of the second glass frit. Alternatively, the particles first glass frit may have a D90 particle size which is lower than the D90 particle size of the particles of the second glass frit, and/or the particles first glass frit may have a D50 particle size which is lower than the D50 particle size of the particles of the second glass frit.

Advantageously, tailoring the particle size of the different glass frits may provide additional control over the temperature of fusion during in firing.

The kit or the particle mixture of the present invention may comprise from 10 to 90 wt % particles of the first glass frit, preferably 20 to 45 wt % of particles of the first glass frit, based on total weight of the kit or particle mixture respectively. The kit or the particle mixture may comprise from 5 to 95 wt % particles of the second glass frit, preferably 20 to 40 wt % particles of the second glass frit, based on total weight of the kit or particle mixture respectively. In some embodiments, the kit or particle mixture of the present invention may comprise a higher amount of the first glass frit than the second glass frit.

In the kit or particle mixture of the present invention, the weight ratio of the first glass frit to the second glass frit is in the range from 1:1 to 10:1, preferably 2:1 to 7:1, more preferably 2:1 to 4:1. For example, the weight ratio of the first glass first to the second glass frit may be approximately 3:1.

The kit or particle mixture may further comprise particles of a pigment, such as a mixed metal oxide pigment or a carbon black pigment. When used, such pigments may constitute no greater than about 55 wt %, preferably 10-25 wt % of the kit or the particle mixture, depending upon the range of colour, gloss, and opacity desired in the final enamel.

In one embodiment, the kit or particle mixture of the present invention may comprise:
a) ≥10 to ≤90 wt % particles of the first glass frit;
b) ≥5 to ≤95 wt % particles of the second glass frit;
c) ≥0 to ≤50 wt % particles of pigment.

In a preferred embodiment, the kit or particle mixture of the present invention may comprise:
a) ≥20 to ≤45 wt % particles of the first glass frit;
b) ≥20 to ≤40 wt % particles of the second glass frit;
c) ≥10 to ≤25 wt % particles of pigment.

Suitable pigments may comprise complex metal oxide pigments, such as corundum-hematite, olivine, priderite, pyrochlore, rutile, and spinel. Other categories such as baddeleyite, borate, garnet, periclase, phenacite, phosphate, sphene and zircon may be suitable in certain applications.

Typical complex metal oxide pigments which may be used to produce black colours in the automotive industry include transition metal oxides having spinel-structure, such as spinel-structure oxides of copper, chromium, iron, cobalt, nickel, manganese, and the like. Although these black spinel pigments are preferred for use in the automotive industry, other metal oxide pigments to produce other various colours can be employed in the present invention. Examples of other end uses include architectural, appliance, and beverage industries.

Examples of commercially available pigments suitable for use in the present invention include CuCr₂O₄, (Co,Fe)(Fe,Cr)₂O₄, (NiMnCrFe), and the like.

Mixtures of two or more pigments may also be employed in the kit or particle mixture of the present invention.

Preferably, the D90 particle size of the particles of pigment is less than or equal to the D90 particle size of one or both of the particles of first glass frit and the particles of second glass frit. More preferably, the D90 particle size of the particles of pigment is less than the D90 particle size of both the particles of first glass frit and the particles of second glass frit.

The D90 particle size of the particles of pigment may be less than 5 microns, less than 4 microns or less than 2 microns. Preferably, the D90 particle size of the particles of pigment is less than 1 micron.

The particle mixture of the present invention may be prepared by mixing particles of the first glass frit and particles of the second glass frit. Where pigment is employed, the particle mixture may be prepared by mixing particles of the first glass frit, particles of the second glass frit and particles of pigment.

The kit or particle mixture of the present invention may be combined with a liquid dispersion medium to form an ink according to the second aspect of the present invention.

As used herein, the term “liquid dispersion medium” refers to a substance which is in the liquid phase at the conditions intended for application of the ink to a substrate (i.e. printing). Thus, at ambient conditions the liquid dispersion medium may be solid or a liquid too viscous for printing. As the skilled person will readily understand, combination of the particle mixture with a liquid dispersion medium may take place at elevated temperature if required.

The liquid dispersion medium to be employed in the present invention may be selected on the basis of the application method to be employed and the intended end use of the enamel. Typically, the liquid dispersion medium comprises an organic liquid.

In one embodiment, the liquid dispersion medium adequately suspends the particle mixture at application conditions, and is removed completely during drying and/or firing or pre-firing of the applied coating of ink. Factors influencing the choice of medium include solvent viscosity, evaporation rate, surface tension, odour and toxicity. Suitable mediums preferably exhibit non-Newtonian behavior at printing conditions. Suitably, the medium comprises one or more of water, alcohols, glycol ethers, lactates, glycol ether acetates, aldehydes, ketones, aromatic hydrocarbons and oils. Mixtures of two or more solvents are also suitable.

In an alternative embodiment, the liquid dispersion medium may be curable on exposure to thermal or actinic (e.g. UV) radiation. In this embodiment, the liquid dispersion medium adequately suspends the particle mixture at application conditions, and is then cured by exposing the applied coating to thermal or actinic radiation. The components of the cured liquid dispersion medium will subsequently be removed during firing or pre-firing of the applied coating. Suitable curable liquid dispersion media may include, for example, cross-linkable acrylates and/or methoacrylates.

Where the ink is to be applied to a substrate via inkjet printing, preferred mediums include diethylene glycol monobutyl ether, dipropylene glycol monomethyl ether, tripropylene glycol monomethyl ether, dibasic esters, and 1-methoxy 2-propanol. A particularly preferred medium comprises dipropylene glycol monomethyl ether.

The ink may further comprise one or more additives. These may include dispersing agents, such as, but not limited to those from the BYKJET, disperBYK, Solsperse or Dispex ranges, in particular BYKJET 9151, resins and/or rheology modifiers.

The ink of the present invention may comprise from about 40 to about 60 wt % of the particle mixture described above, preferably about 45 to about 48 wt %, and may further comprise about 40 to about 60 wt % of liquid dispersion medium, preferably about 52 to about 55 wt %, based on total weight of the ink.

In some embodiments, the ink is preferably substantially lead-free, that is, any lead-containing components are substantially absent from the ink. For example, the ink may comprise less than 0.1 wt % lead.

The rheology of the ink can be adjusted depending on the technique to be used to apply the ink onto a substrate. The viscosity of the ink can be modified by the use of viscous resins such as vinyl, acrylic or polyester resins, solvents, film formers such as cellulosic materials, and the like. For the purposes of inkjet printing, viscosities of less than 50 mPa.s at a shear rate of 1000 s⁻¹ and a temperature of 25° C., preferably less than 20 mPa.s at a shear rate of 1000 s⁻¹ and a temperature of 25° C. are suitable.

The ink of the present invention may be prepared by mixing:
a) the particle mixture described above; and
b) a liquid dispersion medium.

The components may be mixed, for example, using a propeller mixer, a high shear mixer, or a bead-mill. In some embodiments, the liquid dispersion medium and/or the combined components may be heated prior to and/or during mixing.

Prior to mixing with the liquid dispersion medium, the first and/or second glass frits may undergo milling in order to achieve the required particle size. The first and second frits may be milled individually or co-milled. In some cases, the first and/or second glass frits may undergo milling after they have been combined with the liquid dispersion medium. For example, a mixture of particles of the first glass frit, particles of the second glass frit and liquid dispersion medium may undergo milling to provide the ink of the present invention. Alternatively, the ink of the present invention may be prepared by (i) milling a mixture of particles of first glass frit and liquid dispersion medium to provide a first dispersion; (ii) milling a mixture comprising particles of second glass frit and liquid dispersion medium to produce a second dispersion; and (iii) mixing the first and second dispersion. Suitable milling techniques include bead-milling.

The ink of the present invention may be employed in a method of forming an enamel on a substrate. Such a method may comprise applying a coating of an ink as described above onto the substrate, optionally drying the applied coating of ink, and then firing the applied coating.

The coating of ink may be applied to a substrate via a suitable printing method. For example, the coating of ink may be applied to a substrate via inkjet printing, screen printing, roller coating, spraying or by k-bar application. In a preferred embodiment, the ink is applied to the substrate via inkjet printing, wherein ink droplets are discharged by a digitally controlled print head directly onto a substrate. For example, thermal drop-on-demand inkjet printing and piezoelectric drop-on-demand inkjet printing techniques may be suitable.

After application of the ink coating to the substrate and prior to firing, the applied coating may undergo a drying step for removal or partial removal of solvents present in the liquid dispersion medium. Drying may be carried out at temperatures of up to 200° C. Drying may be carried out, for example, by air drying the applied coating at ambient temperature, by heating the ink-coated substrate in a suitable oven, or by exposing the ink-coated substrate to infrared radiation.

Alternatively, where an appropriate liquid dispersion medium is employed, the applied coating may undergo a curing step, for example, by exposing the applied coating to radiation capable of initiating curing.

The applied coating may be fired by heating the coated substrate to a temperature sufficiently high to cause the glass frit to soften and fuse to the substrate, and to burn off any remaining components deriving from the liquid dispersion medium. For example, the firing may be carried out by heating the coated substrate to a temperature in the range 500 to 1000° C., for example, 540 to 840° C. Heating the coated substrate may be carried out using a suitable furnace, such as a continuous line furnace.

Subsequent to any drying or curing steps and prior to firing of the applied coating, the coating may undergo a pre-firing step. As used herein “pre-firing” refers to heating the coated substrate to a temperature in the range >200° C. to 600° C., for removal of non-volatile components deriving from the liquid dispersion medium, for example, non-volatile organics. Pre-firing may be carried out using a suitable furnace, such as a continuous line furnace.

In the method of forming an enamel of the present invention, the substrate to which the ink is applied may be a glass substrate, a ceramic substrate or a metal substrate. In a preferred embodiment the substrate is a glass substrate.

The coating of ink applied to the substrate, prior to any drying, firing or pre-firing steps, may have a thickness (wet film thickness) in the range 7 to 48 microns, preferably 9 to 15 microns.

The thickness of the resulting enamel (after firing) may be less than 12 microns, preferably less than 11 microns, more preferably less than 10 microns.

The particle mixture and ink of the present invention may be employed in the formation of automotive obscuration enamels and decorative and/or functional enamels on glass for other purposes, such as architectural glass, appliance glass, glass bottles etc. Alternatively, the particle mixture of the present invention may be employed in the formation of glass sealants, barrier layers and/or dielectric layers.

The present invention also provides a substrate having an enamel formed thereon, wherein the enamel is obtained or obtainable by applying a coating of an ink as described above onto the substrate and firing the applied coating.

### EXAMPLES

The invention will now be further described with reference to the following examples, which are illustrative, but not limiting of the invention.

### Preparation of Glass Frit Particles

Commercially available glass frits (i), (ii) and (iii) were obtained from Johnson Matthey. Frit (i) (Johnson Matthey product number 5466) is lead-free, boron-free bismuth-silicate glass frit having a silica content of approximately 15 wt %. Frit (ii) (Johnson Matthey product number 5317) is a lead-free, bismuth based frit comprising approximately 13 wt % boron oxide and less than 5 wt % silica. Frit (iii) is a bismuth silicate frit comprising greater than 5 wt % silica and greater than 5 wt % boron oxide (Johnson Matthey product number 5405).

Each of glass frits (i), (ii) and (iii) were subjected to jet milling to provide coarse glass frit particles having a D90 particle size of approximately 5.5 μm. The coarse milled glass frit particles were then subjected to wet bead-milling using a Dispermat bead mill (having a 125 mL milling chamber and using beads having a size of 0.3-0.4 mm at 100 mL volume). For all glass frits, the wet milling mixture comprised 55 wt % glass frit, 44.5 wt % dibasic ester solvent (available from Flexisolv, Europe) and 0.5 wt % BykJet-9151 dispersant (available from Byk). The mixture was bead milled until the glass frit particles had a D90 particle size of approximately 1.4 μm. Particle size of the glass frit was determined using a laser diffraction method using a Malvern Mastersizer 2000.

### Preparation of Particles of Pigment

A commercially available black pigment was obtained from Johnson Matthey (product number JB010F). The pigment was sintered and jet milled and then subjected to wet bead-milling. The wet milling mixture comprised 50 wt % pigment, 48.5 wt % Dibasic Ester and 1.5 wt % BykJet-9151 dispersant. The pigment was bead milled until a D90 particle size of approximately 0.6 μm was achieved. Particle size of the pigment was determined using a laser diffraction method using a Malvern Mastersizer 2000.

### Preparation of Resin

A solution of resin was prepared by heating a mixture comprising 31.4 wt % Joncryl 804 (available from BASF) and 68.6 wt % Dowanol PMA (available from the Dow Chemical Company) to 90° C. with high shear agitation. Heating and agitation of the mixture was continued until a homogenous, clear solution was obtained.

### Preparation of Inks

Suspensions of particles of glass frit (i), particles of glass frit (ii) and pigment particles (suspended in their respective milling solvents) were combined and then mixed with the resin solution prepared as described above, and with Dowanol PMA solvent, BykJet-9151 dispersant and BYK-306 to form Inks 1 to 3. Ink 4 was prepared in the same manner but using particles of glass frit (i) only. Ink 5 was prepared in the same manner but using particles of glass frit (iii). The composition of each ink prepared is set out in Table 1 below.

TABLE 1

| | Ink 1 | Ink 2 | Ink 3 | Ink 4 | Ink 5 |
|---|---|---|---|---|---|
| Component | Wt. % | | | | |
| Suspension comprising | 41.62 | 48.56 | 27.75 | 55.5 | — |
| 55 wt % particles of glass | | | | | |
| frit (i), 44.5 wt % Dibasic | | | | | |
| Ester and 0.5 wt % | | | | | |
| BykJet-9151 | | | | | |
| Suspension comprising | 13.88 | 6.94 | 27.75 | — | — |
| 55 wt % particles of glass | | | | | |
| frit (ii), 44.5 wt % Dibasic | | | | | |
| Ester and 0.5 wt % | | | | | |
| BykJet-9151 | | | | | |
| Suspension comprising | — | — | — | — | 55.5 |
| 55 wt % particles of glass | | | | | |
| frit (iii), 44.5 wt % Dibasic | | | | | |
| Ester and 0.5 wt % | | | | | |
| BykJet-9151 | | | | | |
| Suspension comprising | 21.00 | 21.00 | 21.00 | 21.00 | 21.00 |
| 50 wt % pigment particles | | | | | |
| 48.5 wt % Dibasic Ester | | | | | |
| and 1.5 wt % BykJet-9151 | | | | | |
| Dowanol PMA | 5.00 | 5.00 | 5.00 | 5.00 | 5.00 |
| BykJet-9151 dispersant | 2.50 | 2.50 | 2.50 | 2.50 | 2.50 |
| Byk-306 surfactant | 0.06 | 0.06 | 0.06 | 0.06 | 0.06 |
| Resin solution comprising | 15.94 | 15.94 | 15.94 | 15.94 | 15.94 |
| 31.4 wt % Joncryl 804 and | | | | | |
| 68.6 wt % Dowanol PMA | | | | | |

The weight ratio of frit (i) to frit (ii) in Ink 1 is 3:1. The weight ratio of frit (i) to frit (ii) in Ink 2 is 7:1. The weight ratio of frit (i) to frit (ii) in Ink 3 is 1:1. Inks 1 to 3 comprise a particle mixture according to the present invention and are inks according to the present invention. Inks 4 and 5 do not comprise a particle mixture according to the present invention and are comparative inks.

### Printing

Inks 1 to 5 were printed onto 6×15 cm² glass substrates using a k-bar applicator. The wet layer thickness of each applied coating of ink was approximately 40 microns. The coated substrates were then dried at 150° C. for 10 minutes.

### Firing and Colour Testing

Each coated substrate was then subjected to a 180 second firing cycle in a three-zone gradient kiln to form an enamel. The first, second and third zones of the kiln were set at temperatures of 630° C., 690° C. and 765° C. respectively. In this way, the coated substrate was subjected to a gradient of firing temperatures along its length (i.e. not only to 630° C., 690° C. and 765° C. but also to a range of temperatures in between). On exiting the kiln at the end of firing cycle, the surface temperature along the enamel was measured at 5 mm intervals using a pyrometer placed above the exit of the kiln.

The CIELAB colour space lightness value L* was then determined along each enamel at 10 mm intervals (i.e. at every second temperature measurement point) according to the CIELAB 1976 system using a X-rite 964 spectrophotometer. A lightness value of L*=0 represents the darkest black, and a lightness value of L*=100 represents the brightest white. For automotive black obscuration enamels, a L* value of ≤5 is typically required.

L*ₘᵢₙ is the minimum L* value achievable for a given enamel. Typically, enamels having an L* value ranging between L*ₘᵢₙ and L*ₘᵢₙ+1 are considered acceptable for use in automotive obscuration enamels. L*ₘᵢₙ may be determined by plotting L* on a graph against the surface temperature of the enamel at the end of the firing cycle. L*ₘᵢₙ is the minimum point on the resulting curve.

The useable firing range (or firing window) of a composition for forming an automotive black obscuration enamel is considered to be the temperature range between the minimum temperature at which L*ₘᵢₙ+1 is achieved (T₁) and the maximum temperature at which L*ₘᵢₙ+1 is achieved (T₂).

The L*ₘᵢₙ and the T₁ and T₂ temperatures for each enamel prepared were determined and are shown in Table 2 below. Where T₁ is not reported, T₁ may be lower than the firing temperatures tested. Where T₂ is not reported, T₂ may be a temperature higher than the firing temperatures tested.

TABLE 2

| Ink | L*min | T₁ (° C.) | T₂ (° C.) |
|---|---|---|---|
| 1 | 2.52 | 602 | 635 |
| 2 | 2.69 | 614 | 641 |
| 3 | 3.48 | — | 620 |
| 4 | 15.41 | 678 | — |
| 5 | 3.09 | — | 648 |

As can be seen from the results shown in Table 2, comparative ink 4 comprising only frit (i) (a boron-free, bismuth-silicate glass), does not provide an enamel having a L*ₘᵢₙ+1 value of ≤5, and thus, would be unsuitable for use in the preparation of automotive black obscuration enamels. Further, the minimum firing temperature required in order to achieve L*ₘᵢₙ+1 is significantly higher than for inks 1 to 3.

Surprisingly, inks 1, 2 and 3 (which all contain frit (i) and frit (ii) in varying proportions) provide significantly improved L*ₘᵢₙ values and significantly reduced firing temperatures compared to ink 4. In fact, comparison of ink 2 (having a molar ration of frit (i) to frit (ii) of 7:1) and ink 4 demonstrates that only a relatively small quantity of frit (ii) need be combined with frit (i) in order to for these advantages to be achieved.

As can also be seen from the results shown in Table 2, each of inks 1, 2 and 3 achieve a L*ₘᵢₙ which is comparable to or better than that achieved by comparative ink 5 comprising only frit (iii) (a conventional boron and silicon containing frit).

Furthermore, the results shown in Table 2 demonstrate that, in the particle mixture and ink of the present invention, varying the molar ratio of the first glass frit to the second glass frit may influence the T₁ and T₂ values, the breadth of the firing window and the colour depth achieved.

1. A particle mixture for forming an enamel comprising particles of a first glass frit and particles of a second glass frit; wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns, and wherein the particle mixture further comprises particles of a pigment.

2. A particle mixture as claimed in claim 1 wherein the first glass frit comprises:
>5 to ≤65 wt % SiO₂;
≥0 to ≤50 wt % ZnO;
≥10 to ≤80 wt % Bi₂O₃; and
≥0 to <5 wt % B₂O₃.

3. A particle mixture as claimed in claim 1 wherein the first glass frit comprises ≥10 to ≤65 wt % SiO₂, preferably ≥15 to ≤50 wt % SiO₂.

4. A particle mixture as claimed in claim 1 wherein the second glass frit comprises:
>1 to ≤25 wt % B₂O₃;
≥5 to ≤30 wt % ZnO;
≥40 to ≤70 wt % Bi₂O₃;
≥0 to ≤30 wt % SnO₂;
≥0 to ≤20 wt % Al₂O₃;
≥0 to <5 SiO₂ wt %; and
≥0 to ≤18 wt % alkali metal oxide.

5. A particle mixture as claimed in claim 1 wherein the second glass frit comprises ≥5 to ≤25 wt % B₂O₃, preferably, ≥8 to ≤20 of B₂O₃.

6. A particle mixture as claimed in claim 1 wherein the particles of the first glass frit have a D90 particle size of less than 4.8 microns, less than 4 microns, less than 3.5 microns, less than 3 microns, less than 2.5 microns, less than 2 microns, or less than 1.5 microns.

7. A particle mixture as claimed in claim 1 wherein the particles of the second glass frit have a D90 particle size of less than 4.8 microns, less than 4 microns, less than 3.5 microns, less than 3 microns, less than 2.5 microns, less than 2 microns, or less than 1.5 microns.

8. A particle mixture as claimed in claim 1 wherein the weight ratio of the first glass frit to the second glass frit is in the range from 1:1 to 10:1, preferably 2:1 to 7:1, more preferably 2:1 to 4:1.

9. A particle mixture as claimed in claim 8 wherein the weight ratio of the first glass frit to the second glass frit is about 3:1.

10. (canceled)

11. A particle mixture as claimed in claim 1 which comprises:
≥10 to ≤90 wt % particles of the first glass frit;
≥5 to ≤95 wt % particles of the second glass frit;
≥0 to ≤50 wt % particles of pigment.

12. A particle mixture as claimed in claim 11 which comprises:
≥20 to ≤45 wt % particles of the first glass frit;
≥20 to ≤40 wt % particles of the second glass frit;
≥10 to ≤25 wt % particles of pigment.

13. An ink comprising:
a particle mixture as claimed in claim 1; and
a liquid dispersion medium.

14. (canceled)

15. (canceled)

16. (canceled)

17. (canceled)

18. A method of forming an enamel on a substrate, the method comprising applying a coating of an ink as claimed in claim 13 onto the substrate and firing the applied coating.

19. An article comprising a substrate having an enamel formed thereon, wherein the enamel is obtained or obtainable by the method as claimed in claim 18.

20. Use of a particle mixture comprising particles of a first glass frit and particles of a second glass frit; wherein the first glass frit comprises greater than 5 wt % silicon oxide (SiO₂) and less than 5 wt % boron oxide (B₂O₃);
wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns, and wherein the particle mixture further comprises particles of a pigment or an ink as claimed in claim 13 to form an enamel on substrate.

21. A kit comprising particles of a first glass frit and particles of a second glass frit; wherein the first glass frit comprises greater than 5 wt % silicon oxide (SiO₂) and less than 5 wt % boron oxide (B₂O₃); wherein the second glass frit comprises boron oxide (B₂O₃) and less than 5 wt % of silicon oxide (SiO₂); and wherein both the particles of the first glass frit and the particles of the second glass frit have a D90 particle size of less than 5 microns.
